(19) United States
(12) Patent Application Publication
(10) Pub. No.: US 2005/0108056 A1
(43) Pub. Date: May 19, 2005

(54) Patient identification card and method for HIPAA compliant check-in

(76) Inventor: Ranjan Sachdev, Bethlehem, PA (US)

Correspondence Address: Daniel H. Golub, 1701 Market Street, Philadelphia, PA, 19103, US

(21) Appl. No.: 10/697,791

(22) Filed: Oct. 30, 2003

(51) Int. Cl. G06F 17/60

(52) U.S. Cl. 705/3

(57) ABSTRACT

A HIPAA compliant for patient check-in at an office of a health care provider using a identification card. The card includes a substrate that carries a computer-generated representation of a name of the patient, a name of a medication, a medical condition, treatment, test or procedure, a place and date for when the medical condition was diagnosed, medication was prescribed and medical treatment, test or procedure was performed, a name of a health care provider diagnosing the medical condition, prescribing the medication and performing medical treatment, test or procedure and a result of the medical test. The card also carries an encoded, computer-readable identification number that identifies the patient in a medical information database. The card may also carry a computer-readable code that stores an encoded representation of the human-readable information. An identification card that carries information about a pet. The card includes a substrate that carries a computer-generated representation of a name of the caregiver, name of the pet, name of the pet's species, breed or gender, a name of the veterinarian health care provider, a name of a vaccination, medical test or procedure and result of the medical test. The card also carries an encoded, computer-readable identification number that identifies the pet in a medical information database. The card may also carry a computer-readable code that stores an encoded representation of the human-readable information.

### FIELD OF THE INVENTION

This invention relates to medical identification cards that carry information about medical conditions, treatments, medications, tests and procedures. The present invention is also related to a method for HIPAA compliant check-in at an office of a health care provider. The present invention also relates to a computer system that automatically retrieves patient identification and medial information and prints a form containing this information at patient check-in.

### BACKGROUND OF THE INVENTION

The Health Insurance Portability and Accountability Act of 1996 established Apr. 14, 2003, as the deadline for hospitals, physicians, pharmacies, ancillary healthcare providers, insurance companies and clearinghouses to conform to the final privacy rules. It is desirable for a patient to have an identification card that identifies the patient and provides information pertaining to medical conditions, treatments and procedures. It is further desirable for a health care provider, offering a patient medical treatments or procedures, to have an easy and automatic method to provide HIPAA compliant check-in.

Pets have become a significant aspect of a person's life. It is desirable for a pet caregiver to have an identification card that identifies the pet and provides information pertaining to vaccinations, veterinarian tests and procedures.

### SUMMARY OF THE INVENTION

The present invention is directed to an identification card that carries information about one or more medical conditions diagnosed, medications prescribed and treatments, procedures or tests performed on a holder of the card. The card includes a substrate that carries a human-readable, computer-generated representation of at least: a name of the holder; a name of at least one medical condition diagnosed, medications prescribed and medical treatments, tests or procedures performed on the holder; a place and date on which the at least one medical condition was diagnosed, medication was prescribed, and medical treatment, test or procedure was performed on the holder; a health care provider that diagnosed the medical condition, prescribed the medication and performed the at least one medical treatment, test or procedure on the holder; and if information representing a medical test performed on the holder is included in the computer-generated representation, a result of the medical test. The card also carries an encoded, computer-readable identification number that uniquely identifies the holder in a database that stores medical information about a plurality of holders of identification cards. Alternatively, the card includes a computer-readable code that stores an encoded representation of the human-readable information.

In accordance with a still further aspect, the present invention is directed to a HIPAA compliant method for patient check-in at an office of a health care provider. A patient is provided with an identification card that carries information about one or more medical conditions diagnosed, medications prescribed and medical treatments, procedures or tests performed on the patient. The identification card includes a substrate that carries a human-readable, computer-generated representation of at least: a name of the patient; a name of at least one medical condition diagnosed, medications prescribed and medical treatments, tests or procedures performed on the patient; a place and date on which the at least one medical condition was diagnosed, medication was prescribed, and medical treatment, test or procedure was performed on the patient; a health care provider that diagnosed the medical condition, prescribed the medication and performed the at least one medical treatment, test or procedure on the patient; and if information representing a medical test performed on the patient is included in the computer-generated representation, a result of the medical test. It also includes an encoded, computer-readable identification number that uniquely identifies the patient in a database that stores medical information about a plurality of patients that hold identification cards. The encoded, computer-readable identification number is automatically scanned at the office of the health care provider when the patient arrives at the office. Identification information and medical information about the patient is automatically retrieved from the database in response to the scanning. An image is automatically generated where the image contains the retrieved identification information and the retrieved medical information, and the image is used by the health care provider during an office visit by the patient.

In accordance with a still further aspect, the present invention is directed to a HIPAA compliant method for patient check-in at an office of a health care provider. A patient is provided with an identification card that carries information about one or more medical conditions diagnosed, medications prescribed, and medical treatments, procedures or tests performed on the patient. The identification card includes a substrate that carries a human-readable, computer-generated representation of at least: a name of the patient; a name of at least one medical condition diagnosed, medication prescribed, and medical treatment, test or procedure performed on the patient; a place and date on which the at least one medical condition was diagnosed, medication was prescribed, medical treatment, test or procedure was performed on the patient; a health care provider that diagnosed the medical condition, prescribed the medication, and performed the at least one medical treatment, test or procedure on the patient; and if information representing a medical test performed on the patient is included in the computer-generated representation, a result of the medical test. It also includes a computer-readable code that stores an encoded representation of the human-readable information. The computer-readable code is automatically scanned at the office of the health care provider when the patient arrives at the office. Identification information and medical information, about the patient, is automatically retrieved from the code in response to the scanning. An image is generated where the image contains the retrieved identification information and the retrieved medical information, and the image is used by the health care provider during an office visit by the patient.

In accordance with a still further aspect, the invention is directed to a pet identification card that carries information about one or more vaccinations, medical procedures or tests performed on a pet wherein the pet is cared for by a holder of the card. The card includes a substrate that carries a human-readable, computer-generated representation of at least: a name of the holder; a name of the pet; a name of at least one of the pet's species, breed or gender; a name of at least one vaccination, medical test or procedure performed on the pet; a place and date on which the at least one vaccination, medical test or procedure was performed on the pet; a veterinarian health care provider that performed the at least one vaccination, medical test or procedure on the pet; and if information representing a medical test performed on the pet is included in the computer-generated representation, a result of the medical test. It also includes an encoded, computer-readable identification number that uniquely identifies the pet in a database that stores medical information about a plurality of pets. Alternatively, the card includes a computer-readable identification code that stores an encoded representation of the human-readable information.

### BRIEF DESCRIPTION OF THE DRAWINGS

The accompanying drawings, which are incorporated herein and constitute part of this specification, illustrate the presently preferred embodiment of the invention, and, together with the general description given above and the detailed description given below, serve to explain features of the invention.

FIGS. 1A, 1B show the front and back, respectively, of a patient identification card that carries information about medical conditions, medications and medical treatements, procedures and tests performed on the holder of the card, in accordance with an embodiment of the present invention.

FIGS. 2A, 2B show the front and back, respectively, of a patient identification card that carries information about medical conditions, medications and medical treatments, procedures and tests performed on the holder of the card, in accordance with an embodiment of the present invention.

FIGS. 3A, 3B show the front and back, respectively, of a pet identification card that carries information about vaccinations, medical procedures and tests performed on the pet, in accordance with a further embodiment of the present invention.

FIGS. 4A, 4B show the front and back, respectively, of a pet identification card that carries information about vaccinations, medical procedures and tests performed on the pet, in accordance with a further embodiment of the present invention.

FIG. 5 shows a flow chart illustrating a method of a preferred embodiment of the present invention.

FIG. 6 shows a flow chart illustrating a method of a preferred embodiment of the present invention.

FIG. 7 shows a preferred embodiment of a system used in connection with the present invention.

FIG. 8 shows a preferred embodiment of a system used in connection with the present invention.

Throughout the figures, unless otherwise stated, the same reference numerals and characters denote like features, elements, components, or portions of the illustrated embodiments.

### DETAILED DESCRIPTION OF THE PREFERRED EMBODIMENT

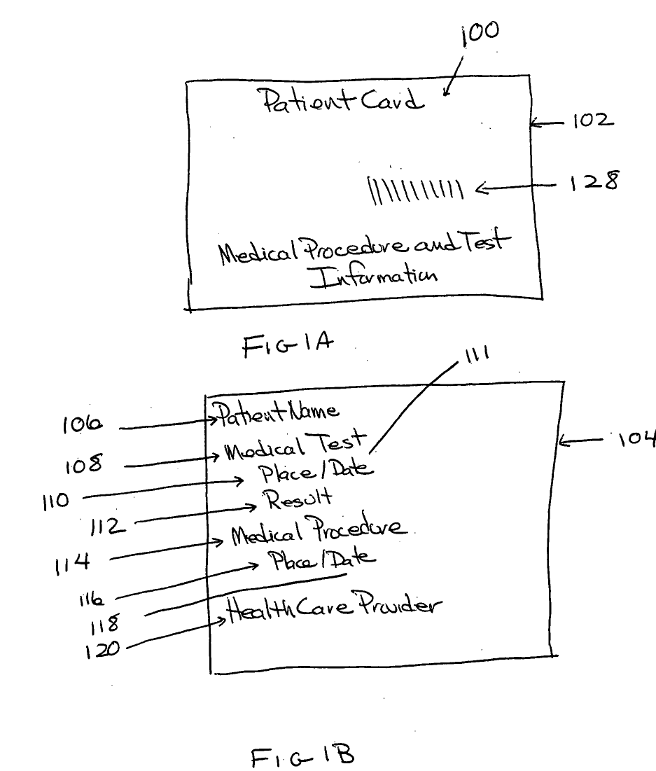

FIGS. 1A, 1B show the front 102 and back 104, respectively, of a patient identification card 100 that carries information about medical procedures and tests performed on the holder of the card. Card 100 preferably is sized like a credit card or driver's license card, such that it can be carried in the wallet of the holder. Card 100 may be formed from a plastic substrate, laminated paper or card stock, or any other suitable substrate material. The substrate carries a computer-generated representation of a name 106 of the holder of the card, the name 120 of the health care provider, a type or name 108 of a medical test, the date 111, place 110 and result 112 of the medical test. It also carries a computer-generated representation of a type or name 114 of a medical procedure, the date 118 and place 116 of the medical procedure. Optionally, the card may carry a computer-generated representation of a medical condition, treatment or prescribed medications. An encoded, computer-readable identification number 128, that uniquely identifies the holder in a database that stores medical information may also be printed in bar code format (or alternatively, encoded on a magnetic strip or using an RF ID tag) on card 100. The encoded, computer readable identification number 128 allows automatic retrieval of identification information and medical information about the patient.

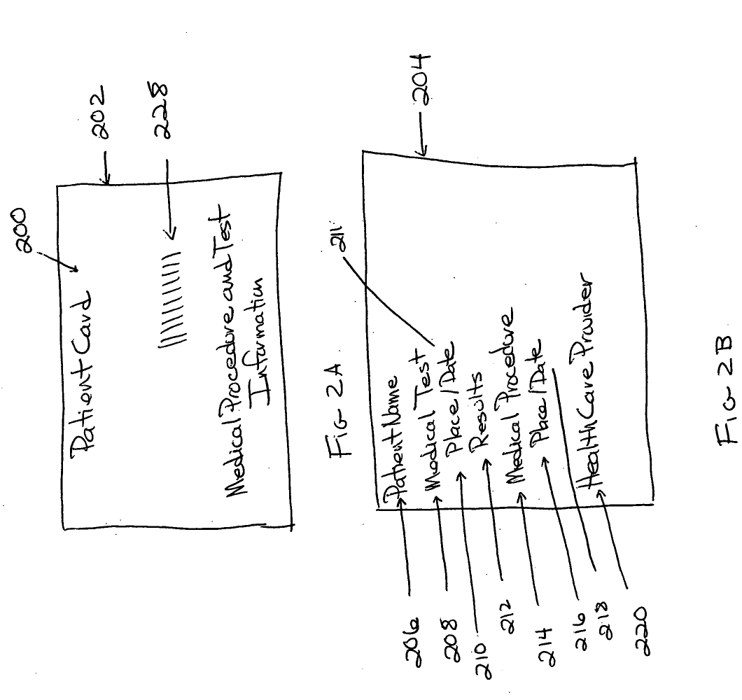

FIGS. 2A, 2B show the front 202 and back 204, respectively, of a patient identification card 200 that carries information about medical procedures and tests performed on the holder of the card. Card 200 preferably is sized like a credit card or driver's license card, such that it can be carried in the wallet of the holder. Card 200 may be formed from a plastic substrate, laminated paper or card stock, or any other suitable substrate material. The substrate carries a computer-generated representation of a name 206 of the holder of the card, the name 220 of the health care provider, a type or name 208 of a medical test, the date 211, place 210 and result 212 of the medical test. It also carries a computer-generated representation of a type or name 214 of a medical procedure, the date 218 and place 216 of the medical procedure. Optionally, the card may carry a computer-generated representation of a medical condition, treatment or prescribed medications. A computer-readable code 228, that stores an encoded representation of the human-readable information, may also be printed in bar code format (or alternatively, encoded on a magnetic strip or using an RF ID tag) on card 200. The computer-readable code 228 allows automatic retrieval of identification information and medical information about the patient.

Cards 100 and 200 carrying the information described above are generated automatically (i.e., using a computer) rather than being hand-written. In one embodiment, the cards are generated using a printer at the patient's primary care physician's office, and updated cards are provided to the patient at the physician's office during normal patient visits. Alternatively, the cards are generated using a printer at a remote site.

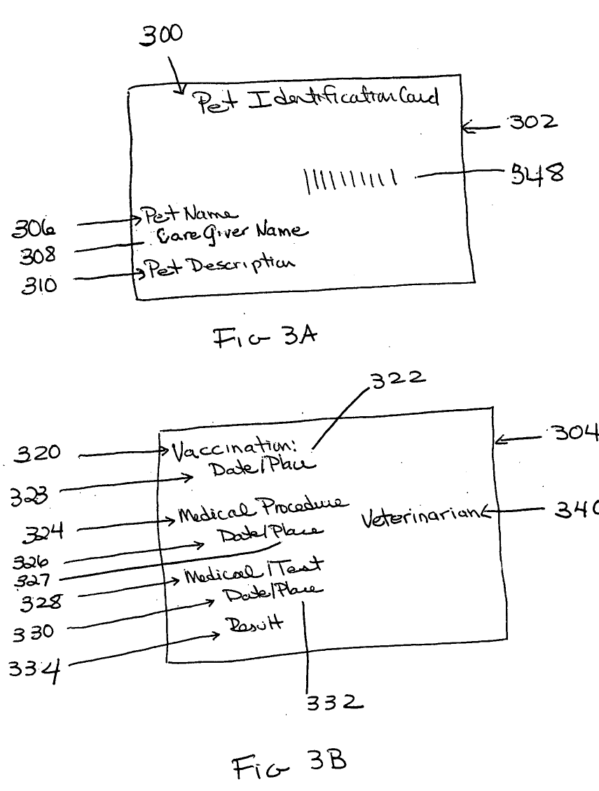

FIGS. 3A, 3B show the front 302 and back 304, respectively, of a pet identification card 300 that carries information about vaccinations, medical procedures and tests performed on the pet. Card 300 preferably is sized like a credit card or driver's license card, such that it can be carried in the wallet of the holder. Card 300 may be formed from a plastic substrate, laminated paper or card stock, or any other suitable substrate material. The substrate carries a computer-generated representation of a name 306 of the pet, a name 308 of the pet's caregiver and a description 310 of the pet. The description may include information such as the pet's species, breed and gender. The substrate carries computer-generated representation of a type or name 320 of a vaccination and the date 322 and place 323 of the vaccination. The substrate carries computer-generated representation of a type or name 324 of a medical procedure performed on the pet and the date 326 and place 327 of the medical procedure. The substrate carries computer-generated representation of a type or name 328 of a medical test performed on the pet and the date 330, place 332 and result 334 of the test. The substrate carries a computer generated representation of a name 340 of the pet's veterinarian care giver. An encoded, computer-readable identification number 348, that uniquely identifies the pet in a database that stores medical information about a plurality of pets, may also be printed in bar code format (or alternatively, encoded on a magnetic strip or using an RF ID tag) on card 300, in order to allow automatic retrieval of identification information and medical information about the pet.

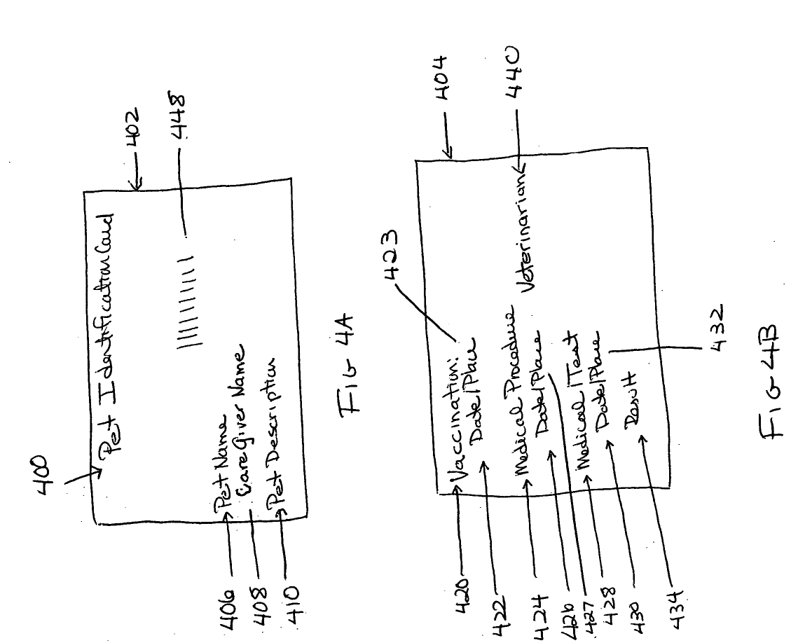

FIGS. 4A, 4B show the front 402 and back 404, respectively, of a pet identification card 400 that carries information about vaccinations, medical procedures and tests performed on the pet. Card 400 preferably is sized like a credit card or driver's license card, such that it can be carried in the wallet of the holder. Card 400 may be formed from a plastic substrate, laminated paper or card stock, or any other suitable substrate material. The substrate carries a computer-generated representation of a name 406 of the pet, a name 408 of the pet's caregiver and a description 410 of the pet. The description may include information such as the pet's species, breed and gender. The substrate carries computer-generated representation of a type or name 420 of a vaccination and the date 422 and place 423 of the vaccination. The substrate carries computer-generated representation of a type or name 424 of a medical procedure performed on the pet and the date 426 and place 427 of the medical procedure. The substrate carries computer-generated representation of a type or name 428 of a medical test performed on the pet and the date 430, place 432 and result 434 of the test. The substrate carries a name 440 of the pet's veterinarian care giver. A computer-readable identification code 448, that stores an encoded representation of the human-readable information, may also be printed in bar code format (or alternatively, encoded on a magnetic strip or using an RF ID tag) on card 400, in order to allow automatic retrieval of identification information and medical information about the pet.

Cards 300 and 400 carrying the information described above are generated automatically (i.e., using a computer) rather than being hand-written. In one embodiment, the cards are generated using a printer at the pet's veterinarian's office, and updated cards are provided to the pet caregiver at the veterinarian's office during normal visits. Alternatively, the cards are generated using a printer at a remote site.

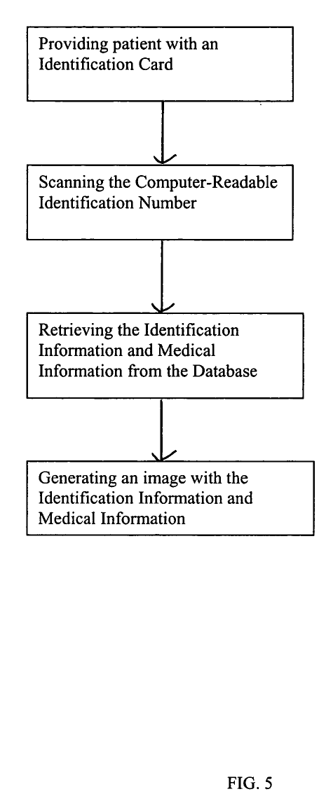

With reference to FIG. 5, a flow chart illustrating a preferred embodiment of the method for HIPAA compliant patient check-in at an office of a health care provider, is shown. In step 510, a patient is provided with an identification card that carries information about one or more medical conditions diagnosed, medications prescribed, and medical treatments, procedures or tests performed on the patient. The identification card includes a substrate that carries a human-readable, computer-generated representation of at least: a name of the patient; a name of at least one medical condition diagnosed, medication prescribed, and medical treatment, test or procedure performed on the patient; a place and date on which the at least one medical condition was diagnosed, medication was prescribed, medical treatment, test or procedure was performed on the patient; a health care provider that diagnosed the medical condition, prescribed the medication and performed the at least one medical treatment, test or procedure on the patient; and if information representing a medical test performed on the patient is included in the computer-generated representation, a result of the medical test. The substrate also carries an encoded, computer-readable identification number that uniquely identifies the patient in a database that stores medical information about a plurality of patients that hold identification cards. In step 514, the encoded, computer-readable identification number is automatically scanned (e.g., using a bar code reader, magnetic strip reader, RFID reader, etc.) at the office of the health care provider when the patient arrives at the office. In step 518, the identification information and medical information is automatically retrieved about the patient from the database in response to the scanning. In step 520, an image, containing the retrieved identification information and the retrieved medical information, is automatically generated, wherein the image is used by the health care provider during an office visit by the patient. The generating of step 520 may be comprised of printing a form containing the retrieved identification information and the retrieved medical information. A physician may use the form to familiarize himself/herself with information about the patient prior to performing an examination or procedure, and/or to document aspects of the patient's visit. Alternatively, the generating in step 520 may be comprised of displaying on a computer screen or a handheld device screen the retrieved identification information and the retrieved medical information.

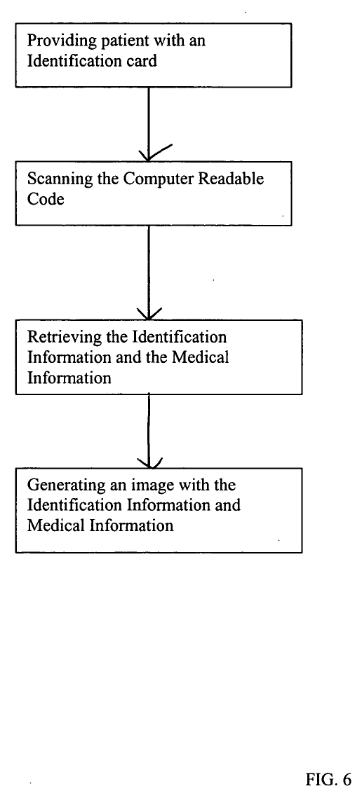

With reference to FIG. 6, a flow chart illustrating a preferred embodiment of the method for HIPAA compliant patient check-in at an office of a health care provider, is shown. In step 610, a patient is provided with an identification card that carries information about one or more medical conditions diagnosed, medications prescribed, medical treatments, procedures or tests performed on the patient. The identification card includes a substrate that carries a human-readable, computer-generated representation of at least: a name of the patient; a name of at least one medical condition diagnosed, medication prescribed and medical treatment, test or procedure performed on the patient; a place and date on which the at least one medical condition was diagnosed, medication was prescribed and medical treatement, test or procedure was performed on the patient; a health care provider that diagnosed the medical condition, prescribed the medication and performed the at least one medical treatment, test or procedure on the patient; if information representing a medical test performed on the patient is included in the computer-generated representation, a result of the medical test. It also carries a computer-readable code that stores an encoded representation of the human-readable information. In step, 630, the computer-readable code is automatically scanned at the office of the health care provider when the patient arrives at the office. In step 640, the identification information and medical information about the patient is automatically retrieved from the code in response to the scanning. In step 650, an image, containing the retrieved identification information and the retrieved medical information, is automatically generated, wherein the image is used by the health care provider during an office visit by the patient. The generating of step 650 may be comprised of printing a form containing the retrieved identification information and the retrieved medical information. A physician may use the form to familiarize himself/herself with information about the patient prior to performing an examination or procedure, and/or to document aspects of the patient's visit. Alternatively, the generating in step 650 may be comprised of displaying on a computer screen or a handheld device screen the retrieved identification information and the retrieved medical information.

Significantly, in the methods of FIGS. 5 and 6, the patient check-in can occur without any need for the patient to sign a “sign-in” sheet which may be read by other patient's that sign-in later, and without the need for the patient or receptionist to state the patient's name aloud such that it could be heard by others in a waiting room.

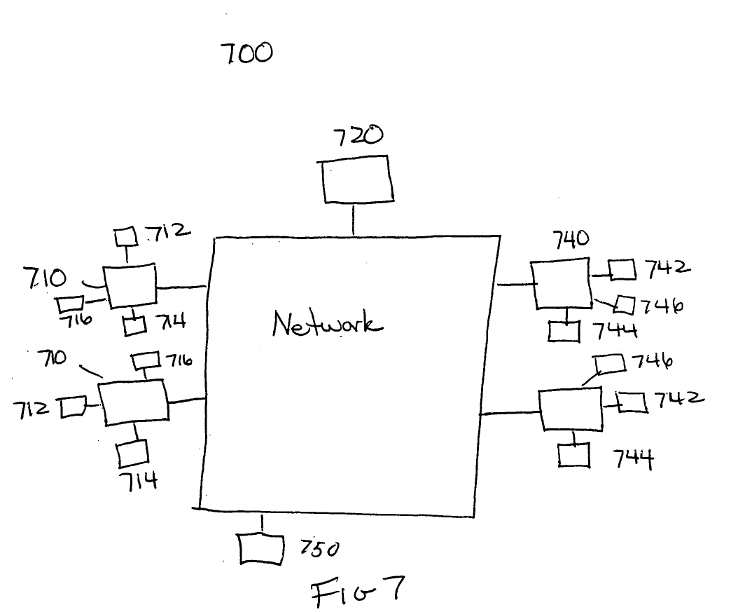

Referring now to FIG. 7, there is shown a computer system 700 for providing HIPAA compliant patient check-in at the office of a health care provider. System 700 includes a plurality of patient terminals 710 each of which is located at an office of a different health care provider. In one embodiment, patient terminals 710 each correspond to a networked personal computer and include a database server 712 for storing information about patients that see the health care provider at the office where the patient terminal 710 is located. Also a scanner 714 is coupled to each patient terminal 710 for scanning a computer-readable identification number or an encoded, computer-readable representation of information carried on the cards. The patient terminals 710 are also coupled to a printer 716 for printing a form containing identification information and medical information about the patient retrieved from the database server 712 or directly from the cards. The printer 716 may also be used to generate cards 100 and 200 or to update cards 100 and 200 after undergoing a medical test or procedure.

System 700 also includes a plurality of health care provider terminals 740 each of which is located at an office of a different health care provider. In one embodiment, healthcare provider terminals 740 each correspond to a networked personal computer and include a database server 742 for storing information about patients that see the health care provider at the office where the patient terminal 710 is located. The health care provider terminals include an input device 744 for entering patient data related to medical tests and procedures. A printer 746 is also coupled to the healthcare provider terminal 740 for printing receipts for payments, future appointments, referrals, etc. An output device 748 is also coupled to the healthcare provider terminal 740 for generating an image containing identification information and medical information about the patient retrieved from the database server 712 or 742, wherein the image is used by the health care provider during an office visit by the patient. Optionally, system 700 could include a plurality of terminals 750 located at pharmacies.

Each local server 712 includes a database that stores information corresponding to each medical information card locally generated by the system. As an alternative to local servers 712, or in combination therewith, information may be stored at a central server 720 which stores information about all identification cards issued by system 700.

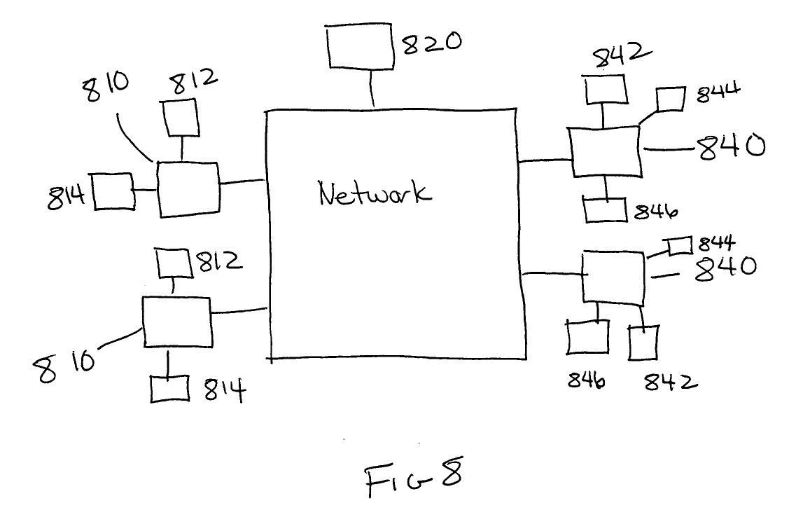

Referring now to FIG. 8, there is shown a computer system 800 that may be used to carry out a further method of the present invention. System 800 includes a plurality of user terminals 810 each of which is located at an office of a different veterinarian care provider. In one embodiment, user terminals 810 each correspond to a networked personal computer and include a database server 812 for storing information about pets that see the veterinarian care provider at the office where the user terminal 810 is located. Also a scanner 814 is coupled to each user terminal 810 for scanning a computer-readable identification number or an encoded, computer-readable representation of information carried on the card. Exemplary uses of the scanning function include, check-in and the transfer of the pet's veterinarian care information to a new veterinarian care provider. The user terminals 810 are also coupled to a printer 816 for printing a form containing vaccination, medical test and procedure information about the pet retrieved from the database server 812. The printer 816 may also be used to generate cards 300 and 400 or to update cards 300 and 400 after undergoing a vaccination and medical test or procedure.

System 800 also includes a plurality of veterinarian care provider terminals 840 each of which is located at an office of a different veterinarian care provider. In one embodiment, veterinarian care provider terminals 840 each correspond to a networked personal computer and include a database server 842 for storing information about pets that see the veterinarian care provider at the office where the user terminal 810 is located. The veterinarian care provider terminals include an input device 844 for entering data related to vaccinations, medical tests and procedures. A printer 846 is also coupled to the veterinarian care provider terminal 840 for printing receipts for payments, future appointments, vaccination information, etc.

Each local server 812 includes a database that stores information corresponding to the each pet identification card locally generated by the system. As an alternative to local servers 812, or in combination therewith, information may be stored at a central server 820 which stores information about all identification cards issued by system 900.

While the principles of the invention have been described above in connection with the specific apparatus and associated methods set forth above, it is to be clearly understood that the above description is made only by way of example and not as a limitation on the scope of the invention as defined in the appended claims.

1. An identification card that carries information about one or more medical treatments, procedures or tests performed on a holder of the card, comprising: a substrate that carries:
(a) a human-readable, computer-generated representation of at least:
(1) a name of the holder;
(2) a name of at least one medical treatment, test or procedure performed on the holder;
(3) a place and date on which the at least one medical treatment, test or procedure was performed on the holder;
(4) a health care provider that performed the at least one medical treatment, test or procedure on the holder; and
(5) if information representing a medical test performed on the holder is included in the computer-generated representation, a result of the medical test; and
(b) an encoded, computer-readable identification number that uniquely identifies the holder in a database that stores medical information about a plurality of holders of identification cards.

2. An identification card that carries information about one or more medical treatments, procedures or tests performed on a holder of the card, comprising: a substrate that carries:
(a) a human-readable, computer-generated representation of at least:
(1) a name of the holder;
(2) a name of at least one medical treatment, test or procedure performed on the holder;
(3) a place and date on which the at least one medical treatment, test or procedure was performed on the holder;
(4) a health care provider that performed the at least one medical treatment, test or procedure on the holder; and
(5) if information representing a medical test performed on the holder is included in the computer-generated representation, a result of the medical test; and
(b) a computer-readable code that stores an encoded representation of the human-readable information.

3. An identification card that carries information about one or more medications prescribed for a holder of the card, comprising: a substrate that carries:
(a) a human-readable, computer-generated representation of at least:
(1) a name of the holder;
(2) a name of at least one mediation prescribed for the holder;
(3) a place and date on which the at least one medication was prescribed for the holder;
(4) a health care provider that prescribed the at least one medication for the holder; and
(b) an encoded, computer-readable identification number that uniquely identifies the holder in a database that stores medical information about a plurality of holders of identification cards.

4. An identification card that carries information about one or more medications prescribed for a holder of the card, comprising: a substrate that carries:
(a) a human-readable, computer-generated representation of at least:
(1) a name of the holder;
(2) a name of at least one medication prescribed for the holder;
(3) a place and date on which the at least one medication was prescribed for the holder;
(4) a health care provider that prescribed the at least one medication for the holder; and
(b) a computer-readable code that stores an encoded representation of the human-readable information.

5. An identification card that carries information about one or more medical conditions diagnosed on a holder of the card, comprising: a substrate that carries:
(a) a human-readable, computer-generated representation of at least:
(1) a name of the holder;
(2) a name of at least one medical condition diagnosed on the holder;
(3) a place and date on which the at least one medical condition was diagnosed on the holder;
(4) a health care provider that diagnosed the at least one medical condition on the holder; and
(5) if information representing a medical condition diagnosed on the holder is included in the computer-generated representation, a diagnosis of the medical condition; and
(b) an encoded, computer-readable identification number that uniquely identifies the holder in a database that stores medical information about a plurality of holders of identification cards.

6. An identification card that carries information about one or more medical conditions diagnosed on a holder of the card, comprising: a substrate that carries:
(a) a human-readable, computer-generated representation of at least:
(1) a name of the holder;
(2) a name of at least one medical condition diagnosed on the holder;
(3) a place and date on which the at least one medical condition was diagnosed on the holder;
(4) a health care provider that diagnosed the at least one medical condition on the holder; and
(5) if information representing a medical condition diagnosed on the holder is included in the computer-generated representation, a diagnosis of the medical condition; and
(b) a computer-readable code that stores an encoded representation of the human-readable information.

7. A HIPAA compliant method for patient check-in at an office of a health care provider, comprising:
(a) providing a patient with an identification card that carries information about one or more medical treatments, procedures or tests performed on the patient, the identification card comprising a substrate that carries:
(1) a human-readable, computer-generated representation of at least:
(a) a name of the patient;
(b) a name of at least one medical treatment, test or procedure performed on the patient;
(c) a place and date on which the at least one medical treatment, test or procedure was performed on the patient;
(d) a health care provider that performed the at least one medical treatment, test or procedure on the patient; and
(e) if information representing a medical test performed on the patient is included in the computer-generated representation, a result of the medical test; and
(2) an encoded, computer-readable identification number that uniquely identifies the patient in a database that stores medical information about a plurality of patients that hold identification cards;
(b) automatically scanning the encoded, computer-readable identification number at the office of the health care provider when the patient arrives at the office, and automatically retrieving identification information and medical information about the patient from the database in response to the scanning; and
(c) automatically generating an image containing the retrieved identification information and the retrieved medical information, wherein the image is used by the health care provider during an office visit by the patient.

8. The method of claim 7, wherein generating further comprises printing a form containing the retrieved identification information and the retrieved medical information, wherein the image is used by the health care provider during an office visit by the patient.

9. The method of claim 7, wherein generating further comprises displaying on at least one of a computer screen or handheld device screen the retrieved identification information and the retrieved medical information, wherein the screen is used by the health care provider during an office visit by the patient.

10. A HIPAA compliant method for patient check-in at an office of a health care provider, comprising:
(a) providing a patient with an identification card that carries information about one or more medical treatments, procedures or tests performed on the patient, the identification card comprising a substrate that carries:
(1) a human-readable, computer-generated representation of at least:
(a) a name of the patient;
(b) a name of at least one medical treatment, test or procedure performed on the patient;
(c) a place and date on which the at least one medical treatment, test or procedure was performed on the patient;
(d) a health care provider that performed the at least one medical treatment, test or procedure on the patient; and
(e) if information representing a medical test performed on the patient is included in the computer-generated representation, a result of the medical test; and
(2) a computer-readable code that stores an encoded representation of the human-readable information;
(b) automatically scanning the computer-readable code at the office of the health care provider when the patient arrives at the office, and automatically retrieving identification information and medical information about the patient from the code in response to the scanning; and
(c) automatically generating an image containing the retrieved identification information and the retrieved medical information, wherein the image is used by the health care provider during an office visit by the patient.

11. The method of claim 10, wherein generating further comprises printing a form containing the retrieved identification information and the retrieved medical information, wherein the form is used by the health care provider during an office visit by the patient.

12. The method of claim 10, wherein generating further comprises displaying on at least one of a computer screen or handheld device the retrieved identification information and the retrieved medical information, wherein the screen is used by the health care provider during an office visit by the patient.

13. A HIPAA compliant method for patient check-in at an office of a health care provider, comprising:
(a) providing a patient with an identification card that carries information about one or more medications prescribed for the patient, the identification card comprising a substrate that carries:
(1) a human-readable, computer-generated representation of at least:
(a) a name of the patient;
(b) a name of at least one medication prescribed for the patient;
(c) a place and date on which the at least one medication was prescribed for the patient;
(d) a health care provider that prescribed the at least one medication for the patient; and
(2) an encoded, computer-readable identification number that uniquely identifies the patient in a database that stores medical information about a plurality of patients that hold identification cards;
(b) automatically scanning the encoded, computer-readable identification number at the office of the health care provider when the patient arrives at the office, and automatically retrieving identification information and medical information about the patient from the database in response to the scanning; and
(c) automatically generating an image containing the retrieved identification information and the retrieved medical information, wherein the form is used by the health care provider during an office visit by the patient.

14. The method of claim 13, wherein generating further comprises printing a form containing the retrieved identification information and the retrieved medical information, wherein the form is used by the health care provider during an office visit by the patient.

15. The method of claim 13, wherein generating further comprises displaying on at least one of a computer screen or handheld device the retrieved identification information and the retrieved medical information, wherein the screen is used by the health care provider during an office visit by the patient.

16. A HIPAA compliant method for patient check-in at an office of a health care provider, comprising:
(a) providing a patient with an identification card that carries information about one or more medications prescribed for the patient, the identification card comprising a substrate that carries:
(1) a human-readable, computer-generated representation of at least:
(a) a name of the patient;
(b) a name of at least one medications prescribed for the patient;
(c) a place and date on which the at least one medication was prescribed for the patient;
(d) a health care provider that prescribed the at least one medication the patient; and
(2) a computer-readable code that stores an encoded representation of the human-readable information;
(b) automatically scanning the computer-readable code at the office of the health care provider when the patient arrives at the office, and automatically retrieving identification information and medical information about the patient from the code in response to the scanning; and
(c) automatically generating an image containing the retrieved identification information and the retrieved medical information, wherein the image is used by the health care provider during an office visit by the patient.

17. The method of claim 16, wherein generating further comprises printing a form containing the retrieved identification information and the retrieved medical information, wherein the form is used by the health care provider during an office visit by the patient.

18. The method of claim 16, wherein generating further comprises displaying at least one of a computer screen or handheld device the retrieved identification information and the retrieved medical information, wherein the screen is used by the health care provider during an office visit by the patient.

19. A HIPAA compliant method for patient check-in at an office of a health care provider, comprising:
(a) providing a patient with an identification card that carries information about one or more medical conditions diagnosed on the patient, the identification card comprising a substrate that carries:
(1) a human-readable, computer-generated representation of at least:
(a) a name of the patient;
(b) a name of at least one medical condition diagnosed on the patient;
(c) a place and date on which the at least one medical condition was diagnosed on the patient;
(d) a health care provider that diagnosed the at least one medical condition on the patient; and
(2) an encoded, computer-readable identification number that uniquely identifies the patient in a database that stores medical information about a plurality of patients that hold identification cards;
(b) automatically scanning the encoded, computer-readable identification number at the office of the health care provider when the patient arrives at the office, and automatically retrieving identification information and medical information about the patient from the database in response to the scanning; and
(c) automatically generating an image containing the retrieved identification information and the retrieved medical information, wherein the image is used by the health care provider during an office visit by the patient.

20. The method of claim 19, wherein generating further comprises printing a form containing the retrieved identification information and the retrieved medical information, wherein the form is used by the health care provider during an office visit by the patient.

21. The method of claim 19, wherein generating further comprises displaying on at least one of a computer screen or handheld device the retrieved identification information and the retrieved medical information, wherein the screen is used by the health care provider during an office visit by the patient.

22. A HIPAA compliant method for patient check-in at an office of a health care provider, comprising:
(a) providing a patient with an identification card that carries information about one or more medical conditions diagnosed on the patient, the identification card comprising a substrate that carries:
(1) a human-readable, computer-generated representation of at least:
(a) a name of the patient;
(b) a name of at least one medical condition diagnosed on the patient;
(c) a place and date on which the at least one medical condition was diagnosed on the patient;
(d) a health care provider that diagnosed the at least one medical condition on the patient; and
(2) a computer-readable code that stores an encoded representation of the human-readable information;
(b) automatically scanning the computer-readable code at the office of the health care provider when the patient arrives at the office, and automatically retrieving identification information and medical information about the patient from the code in response to the scanning; and
(c) automatically generating an image containing the retrieved identification information and the retrieved medical information, wherein the image is used by the health care provider during an office visit by the patient.

23. The method of claim 22, wherein generating further comprises printing a form containing the retrieved identification information and the retrieved medical information, wherein the form is used by the health care provider during an office visit by the patient.

24. The method of claim 22, wherein generating further comprises displaying on at least one of a computer screen or handheld device the retrieved identification information and the retrieved medical information, wherein the screen is used by the health care provider during an office visit by the patient.

25. A pet identification card that carries information about one or more vaccinations, medical procedures or tests performed on a pet wherein the pet is cared for by a holder of the card, comprising: a substrate that carries:
(a) a human-readable, computer-generated representation of at least:
(1) a name of the holder;
(2) a name of the pet;
(3) a name of at least one of the pet's species, breed or gender;
(4) a name of at least one vaccination, medical test or procedure performed on the pet;
(5) a place and date on which the at least one vaccination, medical test or procedure was performed on the pet;
(6) a veterinarian health care provider that performed the at least one vaccination, medical test or procedure on the pet; and
(7) if information representing a medical test performed on the pet is included in the computer-generated representation, a result of the medical test; and
(b) an encoded, computer-readable identification number that uniquely identifies the pet in a database that stores medical information about a plurality of pets.

26. A pet identification card that carries information about one or more vaccinations, medical procedures or tests performed on a pet wherein the pet is cared for by a holder of the card, comprising: a substrate that carries:
(a) a human-readable, computer-generated representation of at least:
(1) a name of the holder;
(2) a name of the pet;
(3) a name of at least one of the pet's species, breed or gender;
(4) a name of at least one vaccination, medical test or procedure performed on the pet;
(5) a place and date on which the at least one vaccination, medical test or procedure was performed on the pet;
(6) a veterinarian health care provider that performed the at least one vaccination, medical test or procedure on the pet; and
(7) if information representing a medical test performed on the pet is included in the computer-generated representation, a result of the medical test; and
(b) a computer-readable identification code that stores an encoded representation of the human-readable information.

27. A method for producing an identification card that carries information about one or more medical treatments, procedures or tests performed on a holder of the card comprising:
(a) generating an identification card at an office of a health care provider comprising:
(1) a substrate that carries a human-readable, computer-generated representation of at least:
(i) a name of the holder;
(ii) a name of at least one medical treatment, test or procedure performed on the holder;
(iii) a place and date on which the at least one medical treatment, test or procedure was performed on the holder;
(iv) the health care provider that performed the at least one medical treatment, test or procedure on the holder; and
(v) if information representing a medical test performed on the holder is included in the computer-generated representation, a result of the medical test; and
(2) an encoded, computer-readable identification number that uniquely identifies the holder in a database that stores medical information about a plurality of holders of identification cards.

28. A method for producing an identification card that carries information about one or more medical treatments, procedures or tests performed on a holder of the card comprising:
(a) generating an identification card at an office of a health care provider comprising:
(1) a substrate that carries a human-readable, computer-generated representation of at least:
(i) a name of the holder;
(ii) a name of at least one medical treatment, test or procedure performed on the holder;
(iii) a place and date on which the at least one medical treatment, test or procedure was performed on the holder;
(iv) the health care provider that performed the at least one medical treatment, test or procedure on the holder; and
(v) if information representing a medical test performed on the holder is included in the computer-generated representation, a result of the medical test; and
(2) a computer-readable code that stores an encoded representation of the human-readable information.

29. A method for producing an identification card that carries information about one or more medications prescribed for a holder of the card comprising:
(a) generating an identification card at an office of a health care provider comprising:
(1) a substrate that carries a human-readable, computer-generated representation of at least:
(i) a name of the holder;
(ii) a name of at least one mediation prescribed for the holder;
(iii) a place and date on which the at least one medication was prescribed for the holder;
(iv) the health care provider that prescribed the at least one medication for the holder; and
(2) an encoded, computer-readable identification number that uniquely identifies the holder in a database that stores medical information about a plurality of holders of identification cards.

30. A method for producing an identification card that carries information about one or more medications prescribed for a holder of the card comprising:
(a), generating an identification card at an office of a health care provider comprising:
(1) a substrate that carries a human-readable, computer-generated representation of at least:
(i) a name of the holder;
(ii) a name of at least one medication prescribed for the holder;
(iii) a place and date on which the at least one medication was prescribed for the holder;
(iv) the health care provider that prescribed the at least one medication for the holder; and
(2) a computer-readable code that stores an encoded representation of the human-readable information.

31. A method for producing an identification card hat carries information about one or more medical conditions diagnosed on a holder of the card comprising:
(a) generating an identification card at an office of a health care provider comprising:
(1) a substrate that carries a human-readable, computer-generated representation of at least:
(i) a name of the holder;
(ii) a name of at least one medical condition diagnosed on the holder;
(iii) a place and date on which the at least one medical condition was diagnosed on the holder;
(iv) the health care provider that diagnosed the at least one medical condition on the holder; and
(v) if information representing a medical condition diagnosed on the holder is included in the computer-generated representation, a diagnosis of the medical condition; and
(2) an encoded, computer-readable identification number that uniquely identifies the holder in a database that stores medical information about a plurality of holders of identification cards.

32. A method for producing an identification card that carries information about one or more medical conditions diagnosed on a holder of the card comprising:
(a) generating an identification card at an office of a health care provider comprising:
(1) a substrate that carries a human-readable, computer-generated representation of at least:
(i) a name of the holder;
(ii) a name of at least one medical condition diagnosed on the holder;
(iii) a place and date on which the at least one medical condition was diagnosed on the holder;
(iv) the health care provider that diagnosed the at least one medical condition on the holder; and
(v) if information representing a medical condition diagnosed on the holder is included in the computer-generated representation, a diagnosis of the medical condition; and
(2) a computer-readable code that stores an encoded representation of the human-readable information.

33. A method for producing a pet identification card that carries information about one or more vaccinations, medical procedures or tests performed on a pet wherein the pet is cared for by a holder of the card, comprising:
(a) generating a pet identification card at an office of a veterinarian health care provider comprising:
(1) a substrate that carries a human-readable, computer-generated representation of at least:
(i) a name of the holder;
(ii) a name of the pet;
(iii) a name of at least one of the pet's species, breed or gender;
(iv) a name of at least one vaccination, medical test or procedure performed on the pet;
(v) a place and date on which the at least one vaccination, medical test or procedure was performed on the pet;
(vi) the veterinarian health care provider that performed the at least one vaccination, medical test or procedure on the pet; and
(vii) if information representing a medical test performed on the pet is included in the computer-generated representation, a result of the medical test; and
(b) an encoded, computer-readable identification number that uniquely identifies the pet in a database that stores medical information about a plurality of pets.

34. A method for producing a pet identification card that carries information about one or more vaccinations, medical procedures or tests performed on a pet wherein the pet is cared for by a holder of the card, comprising:
(a) generating a pet identification card at an office of a veterinarian health care provider comprising:
(1) a substrate that carries a human-readable, computer-generated representation of at least:
(i) a name of the holder;
(ii) a name of the pet;
(iii) a name of at least one of the pet's species, breed or gender;
(iv) a name of at least one vaccination, medical test or procedure performed on the pet;
(v) a place and date on which the at least one vaccination, medical test or procedure was performed on the pet;
(vi) the veterinarian health care provider that performed the at least one vaccination, medical test or procedure on the pet; and
(vii) if information representing a medical test performed on the pet is included in the computer-generated representation, a result of the medical test; and
(b) a computer-readable identification code that stores an encoded representation of the human-readable information.
